(19) United States
(12) Patent Application Publication
(10) Pub. No.: US 2009/0272872 A1
(43) Pub. Date: Nov. 5, 2009

(54) MOUNTING ASSEMBLY TO SECURE A GROMMET TO A COMPRESSOR FOOT INCLUDING DIMPLED SLOT

(76) Inventors: Loren D. Hoffman, Jamestown, IN (US); Holly Thomas, Morgantown, IN (US)

Correspondence Address: CARLSON, GASKEY & OLDS, P.C., 400 WEST MAPLE ROAD, SUITE 350, BIRMINGHAM, MI, 48009, US

(21) Appl. No.: 12/429,396

(22) Filed: Apr. 24, 2009

Related U.S. Application Data
(60) Provisional application No. 61/049,085, filed on Apr. 30, 2008.

(51) Int. Cl. F16M 13/00; A47B 96/06; D07B 1/18

(52) U.S. Cl. 248/673; 248/309.1; 16/2.1

(57) ABSTRACT

A mounting feature secures a grommet to a compressor foot of a compressor. A compressor foot includes a hole and a slot extending between an outer perimeter of the compressor foot and the hole to receive a portion of a grommet. The slot is defined by a first wall and an opposing second wall, and at least one of the first wall and the opposing second wall includes a projection that extends into the slot.

### REFERENCE TO RELATED APPLICATION

This application claims priority to U.S. Provisional Application No. 61/049,085 filed Apr. 30, 2008.

### BACKGROUND OF THE INVENTION

This invention relates generally to a mounting assembly that secures a grommet to a compressor foot of a compressor, the compressor foot including a slot with a projection which assists in mounting and retaining the grommet to the compressor foot.

A compressor of a refrigeration system is mounted to a base pan. The compressor includes a plurality of compressor feet each including a hole, and each of the compressor feet are mounted to the base pan by a mounting bolt that passes through the hole. A rubber grommet is positioned between each compressor foot and the base pan to damp vibrations.

In one prior compressor disclosed in U.S. Pat. No. 6,354,558, the grommet includes a body portion, a neck and a head. A diameter of the head is greater than a diameter of the hole in the compressor foot. A bottom of the compressor foot is pressed onto the head of the grommet, forcing the head of the grommet through the hole of the compressor foot. The neck of the grommet is then received in the hole of the compressor foot, securing the grommet to the compressor foot. A mounting bolt secured to the base pan is received in a central passage of the grommet, securing the compressor foot to the base pan. Securing the grommet to the compressor foot can be difficult as the head must be forced through the opening.

In another prior compressor also described in U.S. Pat. No. 6,354,558, the grommet includes a central passage. The grommet is received between a base pan and a compressor foot. A rubber head is positioned above the compressor foot, and a mounting bolt attached to the base pan extends through the central passage of the grommet, the hole in the compressor foot, and the rubber head to secure the compressor foot to the base pan.

### SUMMARY OF THE INVENTION

Exemplary embodiments of the invention include a mounting feature that secures a grommet to a compressor foot of a compressor. A compressor foot includes a hole and a slot extending between an outer perimeter of the compressor foot and the hole to receive a portion of a grommet. The slot is defined by a first wall and an opposing second wall, and at least one of the first wall and the opposing second wall includes a projection that extends into the slot.

Other exemplary embodiments of the invention include a mounting assembly that secures a compressor foot to a base pan. A mounting bolt is secured to a base pan. A compressor includes a compressor foot including a hole and a slot extending between an outer perimeter of the compressor foot and the hole. The slot is defined by a first wall and an opposing second wall, and at least one of the first wall and the opposing second wall includes a projection that extends into the slot. A portion of a grommet is received in the hole of the compressor foot through the slot. The projection prevents removal of the grommet from the compressor foot through the slot. The mounting bolt is received in a central passage of the grommet to secure the compressor foot to the base pan.

Other exemplary embodiments of the invention include a method of securing a grommet to a compressor foot of a compressor including the step of sliding a portion of a grommet through a slot in a compressor foot. The method further includes the step of compressing a portion of the grommet to allow passage of the portion of the grommet through a portion of the slot having a slot width less than a grommet width. The method further includes the step of receiving the portion of the grommet in a hole of the compressor foot.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 illustrates a refrigeration system;

FIG. 2 illustrates a perspective view of a compressor mounted on a base pan;

FIG. 3 illustrates a top view of a compressor foot of the compressor;

FIG. 4 illustrates a perspective view of the compressor foot mounted on the base pan; and

FIG. 5 illustrates a cross-sectional view of a mounting assembly.

### DETAILED DESCRIPTION OF THE PREFERRED EMBODIMENTS

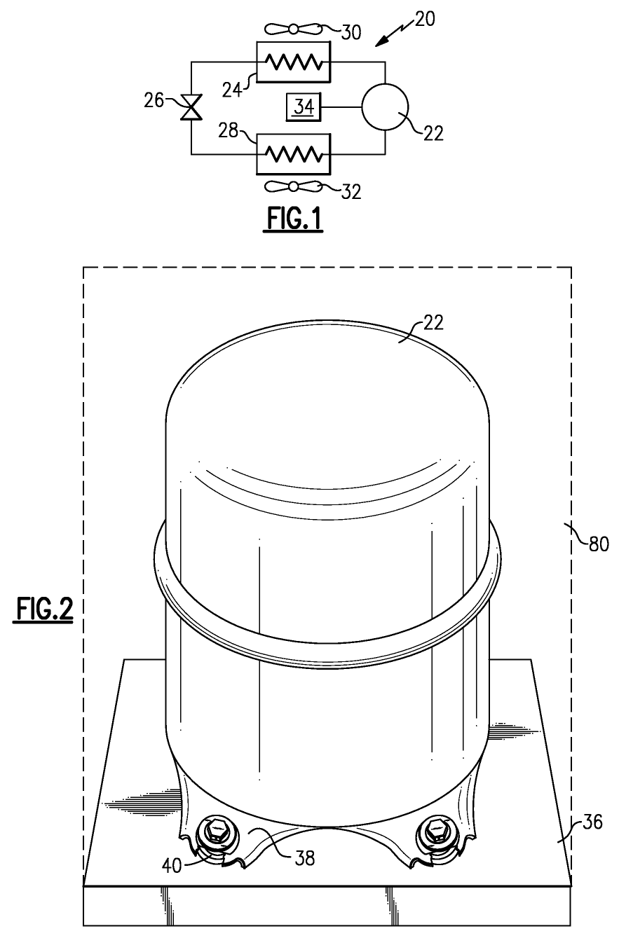

FIG. 1 illustrates a refrigeration system 20 including a compressor 22, a first heat exchanger 24, an expansion device 26, and a second heat exchanger 28. Refrigerant circulates through the closed circuit refrigeration system 20.

When the refrigeration system 20 is operating in a cooling mode, the refrigerant exits the compressor 22 at a high pressure and a high enthalpy and flows through the first heat exchanger 24, which acts as a condenser. In the first heat exchanger 24, the refrigerant rejects heat to air and is condensed into a liquid that exits the first heat exchanger 24 at a low enthalpy and a high pressure. A fan 30 directs the air through the first heat exchanger 24. The cooled refrigerant then passes through the expansion device 26, expanding the refrigerant to a low pressure. After expansion, the refrigerant flows through the second heat exchanger 28, which acts as an evaporator. In the second heat exchanger 28, the refrigerant accepts heat from air, exiting the second heat exchanger 28 at a high enthalpy and a low pressure. A fan 32 blows air through the second heat exchanger 28. The refrigerant then flows to the compressor 22, completing the cycle.

When the refrigeration system 20 is operating in a heating mode, the flow of the refrigerant is reversed with a four-way valve 34. The first heat exchanger 24 accepts heat from the air and functions as an evaporator, and the second heat exchanger 28 rejects heat to the air and functions as a condenser.

FIG. 2 illustrates a perspective view of the compressor 22 mounted on a base pan 36 of a unit 80. The compressor 22 includes at least one compressor foot 38 that is mounted to the base pan 36. The compressor foot 38 and the base pan 36 are made of metal. In one example, the compressor 22 includes four compressor feet 38. A scroll compressor is shown in FIG. 2. However, the invention is applicable to any type of compressor 22.

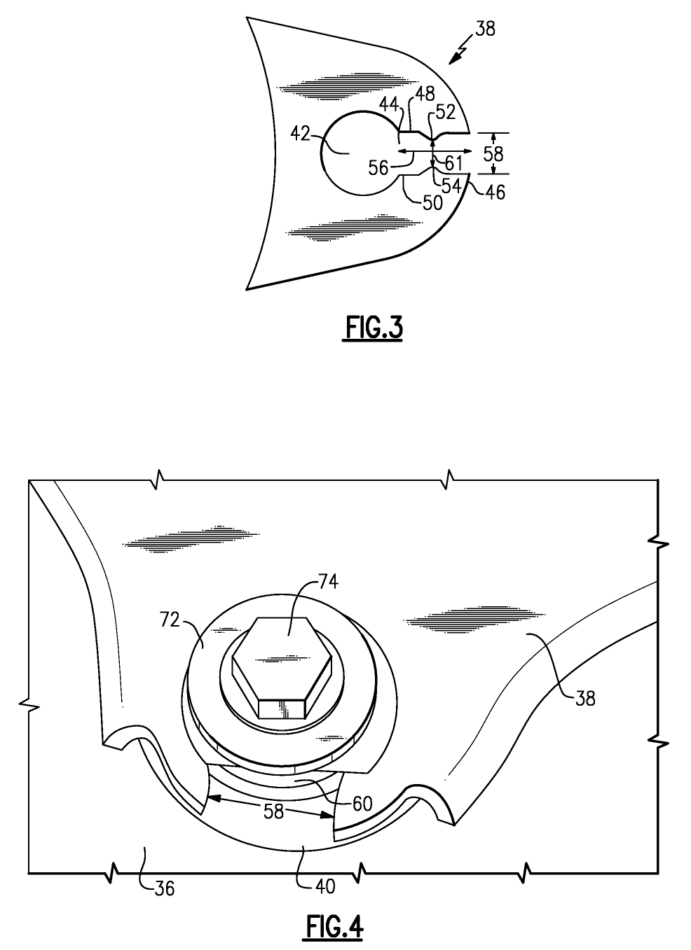

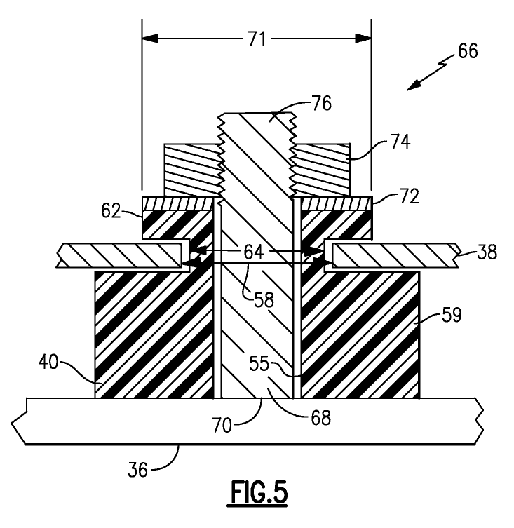

As shown in FIGS. 3 and 4, each of the compressor feet 38 includes a hole 42 and a slot 44 that extends from an outer perimeter 46 of the compressor foot 38 to the hole 42. The slot 44 is substantially straight and is defined by a first wall 48 and an opposing second wall 50. The slot 44 has a length 56.

At least one of the first wall 48 and the opposing second wall 50 includes a projection 52 and 54, respectively (or dimple). In one example, both the first wall 48 and the opposing second wall 50 include the projection 52 and 54, respectively. In one example, the projections 52 and 54 are identical. The projections 52 and 54 can have any shape, and specifically could have a rounded or triangular shape. In one example, the projections 52 and 54 extend inwardly into the slot 44 and substantially perpendicular to the walls 48 and 50. In one example, the projections 52 and 54 are aligned and located substantially in the center of the length 56 of the slot 44.

The slot 44 has a width 58, and a width 61 between the projections 52 and 54 is less than the width 58 of the slot 44. In one example, the width 58 is constant along the length 56 of the slot 44, except at the location of the projections 52 and 54, which define the reduced width 61. However, the slot 44 could also include a flared end (as shown in FIG. 4) or a triangular shaped end. That is, the slot 44 can have a wider opening near the outer perimeter 46 of the compressor foot 38 and a narrower opening near the hole 42.

FIG. 5 illustrates a cross-sectional view of a mounting assembly 66. A grommet 40 is secured to each of the compressor feet 38. Each grommet 40 is made of a resilient material. In one example, each grommet 40 is made of rubber. The grommets 40 prevent metal-to-metal contact between the compressor feet 38 and the base pan 36 and dampen vibrations.

Each grommet 40 includes a central passage 55, a body potion 59, a neck 60 and a head 62. A width 64 of the neck 60 is less than a width 71 of the head 62. The width 64 of the neck 60 of the grommet 40 is less than the width 58 of the slot 44 of the compressor foot 38, but greater than the width 61 between the projections 52 and 54.

When mounting the grommet 40 to one of the compressor feet 38, the grommet 40 is positioned near the outer perimeter 46 of the compressor foot 38 and aligned with the slot 44. The neck 60 of the grommet 40 is then slid through the slot 44. As the width 64 of the neck 60 is less than the width 58 of the slot 44, the grommet 40 freely passes through the slot 44. As the grommet 40 reaches the projections 52 and 54, the grommet 40 slightly compresses to allow passage of the neck 60 of the grommet 40 through the narrower width 61 of the slot 44. The grommet 40 then enters the hole 42, attaching the grommet 40 to the compressor foot 38. The grommet 40 is attached from the side (and not the bottom) of the compressor foot 38.

As the width 61 of the slot 44 defined by the projections 52 and 54 is less than the width 64 of the neck 60 of the grommet 40, the projections 52 and 54 provide a slight interference and prevent the grommet 40 from freely sliding out of the hole 42. This facilitates assembly of the grommet 40 to the compressor foot 32 and reduces installation time.

A mounting bolt 68 secured to the base pan 36 is used to secure the compressor foot 32 with the attached grommet 40 to the base pan 36. The number of mounting bolts 68 equals the number of compressor feet 32, and the mounting bolts 68 are positioned at a location and orientation that corresponds to the location and orientation of the compressor feet 32. The mounting bolt 68 is secured to the base pan 36 at an attachment location 70. The mounting bolt 68 can be secured to the base pan 36 by welding or by a threaded connection.

The compressor foot 32 is positioned on the base pan 36 such that the mounting bolt 68 is received in the central passage 55 of the grommet 40. A washer 72 is positioned on top of the mounting bolt 68. An internally threaded nut 74 is threaded on an externally threaded upper portion 76 of the mounting bolt 68, securing the compressor foot 32 to the base pan 36 and slightly compressing the grommet 40.

Sliding the neck 60 of the grommet 40 through the slot 44 from the side of the compressor foot 38 facilitates attachment of the grommet 40 to the compressor foot 38 as the head 62 of the grommet 40 does not need to be forced through the smaller hole 42 in the compressor foot 38, reducing the force on the compressor foot 38 during installation of the grommet 40. Installation is also facilitated as the neck 60 is only compressed when passing between the projections 52 and 54 of the slot 44, and the projections 52 and 54 prevent the grommet 40 from detaching from the compressor foot 38.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A mounting feature to secure a grommet to a compressor foot of a compressor, the mounting feature comprising:
a compressor foot including a hole and a slot extending between an outer perimeter of the compressor foot and the hole to receive a portion of a grommet, wherein the slot is defined by a first wall and an opposing second wall, and at least one of the first wall and the opposing second wall includes a projection that extends into the slot.

2. The mounting feature as recited in claim 1 wherein both the first wall and the opposing second wall include the projection, the projections extending inwardly into the slot.

3. The mounting features as recited in claim 2 wherein the projections are identical.

4. The mounting feature as recited in claim 1 wherein the slot has a length, and the projection is located in a middle of the length of the slot.

5. The mounting feature as recited in claim 1 wherein the compressor foot is mounted to a base pan.

6. The mounting feature as recited in claim 1 further including a grommet including a body portion, a neck and a head, wherein the neck of the grommet is slid along the slot and received in the hole, the projection preventing removal of the grommet from the compressor foot through the slot.

7. The mounting feature as recited in claim 6 wherein a mounting bolt is secured to a base pan, wherein the mounting bolt is received in a central passage of the grommet to secure the compressor foot to the base pan.

8. A mounting assembly to secure a compressor foot to a base pan, the mounting assembly comprising:
a base pan, wherein a mounting bolt is secured to the base pan;
a compressor including a compressor foot, the compressor foot including a hole and a slot extending between an outer perimeter of the compressor foot and the hole, wherein the slot is defined by a first wall and an opposing second wall, and at least one of the first wall and the second wall include a projection that extends into the slot; and
a grommet including a portion received in the hole of the compressor foot, wherein the projection prevents removal of the grommet from the compressor foot through the slot, and the mounting bolt is received in a central passage to secure the compressor foot to the base pan.

9. The mounting assembly as recited in claim 8 wherein both the first wall and the opposing second wall include the projection, the projections extending inwardly into the slot.

10. The mounting assembly as recited in claim 9 wherein the projections are identical.

11. The mounting assembly as recited in claim 8 wherein the slot has a length, and the projection is located in a middle of the length of the slot.

12. The mounting assembly as recited in claim 8 wherein the grommet includes a body portion, a neck and a head, wherein the neck of the grommet is slid along the slot and received in the hole

13. The mounting assembly as recited in claim 8 wherein the grommet is made of rubber and the base pan and the compressor foot are made of metal.

14. The mounting assembly as recited in claim 8 wherein the grommet is positioned between the base pan and the compressor foot.

15. A method of securing a grommet to a compressor foot of a compressor, the method comprising the steps of:
sliding a portion of a grommet through a slot in a compressor foot;
compressing the portion of the grommet to allow passage of the portion of the grommet through a portion of the slot having a slot width less than a grommet width; and
receiving the portion of the grommet in a hole of the compressor foot.

16. The method as recited in claim 15 further including the step of inserting a mounting bolt secured to a base pan through a central passage of the grommet to secure the compressor foot to the base pan.
